(19) United States
(12) Patent Application Publication
(10) Pub. No.: US 2025/0192142 A1
(43) Pub. Date: Jun. 12, 2025

(54) HIGH-DUCTILITY BATTERY ALUMINUM FOIL AND PREPARATION METHOD THEREOF

(71) Applicants: ZHEJIANG YONGJIE ALUMINUM CO., LTD, HANGZHOU (CN); YONGJIE NEW MATERIAL CO.,LTD, HANGZHOU (CN)

(72) Inventors: DENGBIN CHEN, HANGZHOU (CN); SHENG LIN, HANGZHOU (CN); JIANGUO SHEN, HANGZHOU (CN); GUOHUA ZHANG, HANGZHOU (CN); ZHIWEN HOU, HANGZHOU (CN); PAN SONG, HANGZHOU (CN); ZEHUI XU, HANGZHOU (CN); ZEQUAN WAN, HANGZHOU (CN)

(21) Appl. No.: 18/433,429

(22) Filed: Feb. 6, 2024

Related U.S. Application Data
(63) Continuation of application No. PCT/CN2023/139262, filed on Dec. 15, 2023.

(30) Foreign Application Priority Data
Dec. 6, 2023 (CN) 202311665765.2

(51) Int. Cl. H01M 4/1395; H01M 4/46; H01M 10/0562

(52) U.S. Cl. CPC H01M 4/1395; H01M 4/463; H01M 10/0562

(57) ABSTRACT

A high-ductility battery aluminum foil and preparation method thereof are disclosed. The high-ductility battery aluminum foil includes a first component and a second component. The first component includes Si, Fe, and Cu. The second component is Al. In a cross-section of the high ductility battery aluminum foil, a presence of iron-containing second phase with an equivalent circular diameter of 0.2˜3 μm is in a range of 1.1×10²˜4×10⁴ particles/mm². A presence of metal intermetallic compounds, with an equivalent circular diameter of 0.2˜3 μm, formed by Si and Cu respectively with Al, is not greater than 1.1×10² particles/mm². A presence of elemental silicon particles, with an equivalent circular diameter of 0.2˜3 μm, is not greater than 1.1×10² particles/mm². The high-ductility battery aluminum foil has a thickness not greater than 13 μm, a tensile strength not less than 250 MPa, and an elongation not less than 5%.

The present disclosure relates to a technical field of aluminum processing, and more particular to a high-ductility battery aluminum foil and preparation method thereof.

### BACKGROUND

As power battery develop, in order to achieve higher energy density, a compaction density is continuously increased while an aluminum foil is thinned, to avoid breaking in a compaction process. To reduce a breakage frequency of battery aluminum foils, one of most effective methods is to simultaneously increase a tensile strength and an elongation of the battery aluminum foils. However, there is an “inverted” relationship between the tensile strength and the elongation of the battery aluminum foils, that is, the higher the tensile strength of the battery aluminum foils, the lower the elongation of the battery aluminum foils. Therefore, a feasible technical approach to break the “inverted” relationship is grain refinement. However, under industrial production conditions, there is a significant “ceiling” for grain refinement and achieving an improvement in elongation beyond the “ceiling” proves particularly challenging.

To improve the tensile strength of the battery aluminum foils, elements such as Mg, Cu, Mn are added into the battery aluminum foils. The tensile strength of the battery aluminum foils is improved by coordination effect of the elements while the elongation thereof is greater than 2%. Such method is commonly employed in related art. However, there are no published patent reports on how to further significantly increase the elongation (elongation≥5%) of a thinned battery aluminum foil (thickness≤13 μm) while maintaining high strength (tensile strength≥250 MPa).

The CN patent applicant No. 201110076608.9 discloses a method for manufacturing pure aluminum hard foil for battery current collectors. By adding elements such as iron, copper, and manganese, controlling a content of silicon, refining the grain size during intermediate annealing, and controlling the number of sub-crystals in a cross-section thereof, the pure aluminum hard foil maintains a tensile strength of 220-270 MPa while achieving an elongation of ≥4%.

The CN patent applicant No. 201510415406.0 discloses a production method of an aluminum foil for lithium batteries. In the method, copper elements are added during a casting and rolling melting process to alter the synergistic effect between different elements. Additionally, sizes of grains thereof are refined through two intermediate annealing processes, enabling the aluminum foil to have a tensile strength of 160˜190 MPa and an elongation of ≥1.5%.

The CN patent applicant No. 201710317640.9 discloses a production method of a high-performance aluminum foil for batteries. By adding copper elements and further controlling contents of iron and silicon, the high-performance aluminum foil aluminum foil has a tensile strength of ≥230MPa and an elongation of ≥2.5%.

To sum up, in proposed solutions of the relevant art it is found that no matter what attempts are made, it is not possible to manufacture the battery aluminum foil with the thickness not greater than 13 μm, the tensile strength not less than 250 MPa, and the elongation not less than 5%.

### SUMMARY

The present disclosure provides a high-ductility battery aluminum foil and preparation method thereof, aiming to solve above existing technical problems.

In a first aspect, a high-ductility battery aluminum foil includes a first component and a second component. The first component includes 0.25˜0.40% of Si by mass friction, 0.30˜0.50% of Fe by mass friction, and 0.02˜0.10% of Cu by mass friction. The second component is Al. A mass fraction ratio of Fe to Si is 1.0˜2.0. A presence of iron-containing second phase with an equivalent circular diameter of 0.2˜3 μm. In a cross-section of the high ductility battery aluminum foil, is in a range of 1.1×10²˜4×10⁴ particles/mm². A presence of metal intermetallic compounds, with an equivalent circular diameter of 0.2˜3 μm, formed by Si and Cu respectively with Al, in the cross-section of the high ductility battery aluminum foil, is not greater than 1.1×10² particles/mm². A presence of elemental silicon particles, with an equivalent circular diameter of 0.2˜3 μm, in the cross-section of the high ductility battery aluminum foil, is not greater than 1.1×10² particles/mm².

In one optional embodiment, the first component further includes a first group of elements. The first group of elements in the high-ductility battery aluminum foil includes following components by mass fraction: Mg≤0.20%, Mn≤0.20%, one or more rare earth elements≤0.15%.

In one optional embodiment, the first component further includes one or more elements in a second group of elements; the second group of elements in the high-ductility battery aluminum foil includes following components by mass fraction: Cr≤0.20%, Zn≤0.20%, Ni≤0.20% and V≤0.20%.

In one optional embodiment, the first component further includes one or more elements in a third group of elements. The third group of elements in the high-ductility battery aluminum foil includes following components by mass fraction: Ti≤0.20%, Zr≤0.20%, and Co≤0.20%.

In one optional embodiment, the first component further includes one or more elements in sub-elements of the third group of elements. The sub-elements of the third group of elements in the high-ductility battery aluminum foil include following components by mass fraction: Ti≤0.20%, Zr≤0.20% and Co≤0.20%.

In one optional embodiment, the first component further includes one or more elements in a fourth group of elements. The fourth group of elements in the high-ductility battery aluminum foil includes following components by mass fraction: Be≤0.15%, Bi≤0.15%, Sr≤0.15% and In≤0.15%.

In one optional embodiment, the first component further includes one or more elements in first sub-elements of a fourth group of elements. The first sub-elements of the fourth group of elements in the high-ductility battery aluminum foil include following components by mass fraction: Be≤0.15%, Bi≤0.15%, Sr≤0.15% and In≤0.15%.

In one optional embodiment, the first component further includes one or more elements in second sub-elements of the fourth group of elements. The second sub-elements of the fourth group of elements in the high-ductility battery aluminum foil include following components by mass fraction: Be≤0.15%, Bi≤0.15%, Sr≤0.15% and In≤0.15%.

In one optional embodiment, the first component further includes one or more elements in third sub-elements of the fourth group of elements. The third sub-elements of the fourth group of elements in the high-ductility battery aluminum foil include following components by mass fraction: Be≤0.15%, Bi≤0.15%, Sr≤0.15% and In≤0.15%.

In a second aspect, the present disclosure provides a method for preparing a high-ductility battery aluminum foil, including following steps:
S1: according to above components and mass fraction of the high-ductility battery aluminum foil, performing double-roller continuous casting-rolling to obtain a cast-rolled coil;
S2: performing cold rolling on the cast-rolled coil to obtain an aluminum foil blank; and
S3: performing foil rolling on the aluminum foil blank to obtain the high-ductility battery aluminum foil with a thickness not greater than 13 μm.

Before performing the cold rolling, a thickness of the cast-rolled coil is h0; and after the foil rolling is performed on the aluminum foil blank, the thickness of the high-ductility battery aluminum foil is h; an equivalent strain coefficient is ln(h0/h)≥3.9.

In one optional embodiment, a sub-grain diameter of the high-ductility battery aluminum foil is not greater than 2.5 μm, and a sub-grain area ratio of the high-ductility battery aluminum foil is not less than 55%.

Compared with the prior art, the high-ductility battery aluminum foil in the present disclosure is easily prepared by limiting its components and mass fractions, as well as the presence range of each element in the cross-section of the high ductility battery aluminum foil; and by employing the method for preparing the high-ductility battery aluminum foil, the high-ductility battery aluminum foil with the thickness not greater than 13 μm, the tensile strength not less than 250 MPa, and the elongation not less than 5% is obtained.

### BRIEF DESCRIPTION OF DRAWINGS

To more clearly illustrate technical solutions of embodiments of the present disclosure, the present disclosure will be described in detail in the following by referring to the accompanying drawings and detailed embodiments. Obviously, the accompanying drawings in the following description show only part of the embodiments of the present disclosure. Any ordinary skilled person in the art may obtain other accompanying drawings according to these drawings without making any creative work.

FIG. 1 is a schematic flow chart of a method for preparing a high-ductility battery aluminum foil according to one embodiment of the present disclosure.

FIG. 2 is a cloud diagram of sub-grain distribution of the high-ductility battery aluminum foil according to one embodiment of the present disclosure.

### DETAILED DESCRIPTION

Technical solutions in embodiments of the present disclosure will be described clearly and completely in the following. Apparently, the described embodiments are only a part of but not all the embodiments of the present disclosure. All other embodiments, which are obtained by any ordinary skilled person in the art based on the embodiments in the present disclosure without making creative work, shall fall within the protection scope of the present disclosure.

### Embodiment 1

In the present embodiment, a high-ductility battery aluminum foil includes a first component and a second component. The first component includes 0.25˜0.40% of Si by mass fraction, 0.30˜0.50% of Fe by mass fraction, 0.02˜0.10% of Cu by mass fraction. The scone component is Al. A mass fraction ratio of Fe to Si is 1.0˜2.0. A presence of iron-containing second phase, with an equivalent circular diameter of 0.2˜3 μm, in a cross-section of the high ductility battery aluminum foil, is in a range of 1.1×10²˜4×10⁴ particles/mm². A presence of metal intermetallic compounds, with an equivalent circular diameter of 0.2˜3 μm, formed by Si and Cu respectively with Al, in the cross-section of the high ductility battery aluminum foil, is not greater than 1.1×10² particles/mm². A presence of elemental silicon particles, with an equivalent circular diameter of 0.2˜3 μm, in the cross-section of the high ductility battery aluminum foil, is not greater than 1.1×10² particles/mm².

Above-mentioned elements are main elements of the high-ductility battery aluminum foil.

In one optional embodiment of the present disclosure, the first component further includes a first group of elements. The first group of elements, in the high-ductility battery aluminum foil, includes following components by mass fraction: Mg≤0.20%, Mn≤0.20%, one or more rare earth elements≤0.15%. A presence of intermetallic compounds, with an equivalent circular diameter of 0.2˜3 μm, formed by Mg, element Mn, and the one or more rare earth elements respectively with Al, in the cross-section of the high-ductility battery aluminum foil, is not greater than 1.1×10² particles/mm².

Regardless of whether one or more of the rare earth elements are selected, the mass fraction of the rare earth elements, in the high-ductility battery aluminum foil, is not greater than 0.15%.

In one optional embodiment of the present disclosure, the first component further includes one or more elements in a second group of elements. The second group of elements in the high-ductility battery aluminum foil includes following components by mass fraction: Cr≤0.20%, Zn≤0.20%, Ni≤0.20% and V≤0.20%.

In one optional embodiment of the present disclosure, the first component further includes one or more elements in a third group of elements. The third group of elements in the high-ductility battery aluminum foil includes following components by mass fraction: Ti≤0.20%, Zr≤0.20%, and Co≤0.20%.

In one optional embodiment of the present disclosure, the first component further includes one or more elements in a fourth group of elements. The fourth group of elements, in the high-ductility battery aluminum foil, includes following components by mass fraction: Be≤0.15%, Bi≤0.15%, Sr≤0.15% and In≤0.15%.

Specifically, the main elements is employed in any combination with the above-mentioned first group of elements, the second group of elements, the third group of elements, and the fourth group of elements according to the actual situation. For instance, the main elements are employed in combination with the first group of elements; the main elements are employed in conjunction with the first group of elements and the second group of elements; the main elements are employed in conjunction with the first group of elements, the second group of elements, and the third group of elements; the main elements are employed in conjunction with the first group of elements, the second group of elements, the third group of elements, and the fourth group of elements; the main elements are employed in combination with the second group of elements; the main elements are employed in conjunction with the second group of elements and the third group of elements; the main elements are employed in conjunction with the second group of elements, the third group of elements and the fourth group of elements; the main elements are employed in combination with the third group of elements; the main elements are employed in conjunction with the third group of elements and the fourth group of elements; or the main elements are employed in combination with the fourth group of elements.

Specifically, the iron-containing second phase, with the equivalent circular diameter of 0.2˜3 μm, includes an iron-containing multicomponent phase formed by Mn and the rare earth elements respectively with Fe.

Specifically, a presence of a second intermetallic compound, with an equivalent circular diameter of 0.2˜3 μm, formed by the elements selected from the second group of elements, the third group of elements, and the fourth group of elements respectively with Al, in the cross-section of the high ductility battery aluminum foil, is not greater than 1.1×10² particles/mm².

Specifically, a sub-grain diameter of the high-ductility battery aluminum foil is not greater than 2.5 μm, and a sub-grain area ratio of the high-ductility battery aluminum foil is not less than 55%.

In the present disclosure, by defining the components and mass fractions in the high-ductility battery aluminum foil, the range of the presence of each of the elements in the cross-section of the high-ductility battery aluminum foil, and through a methods of preparing the high-ductility battery aluminum foil, the high-ductility battery aluminum foil with a thickness not greater than 13 μm, a tensile strength not less than 250 MPa, and a elongation not less than 5% is obtained.

### Embodiment 2

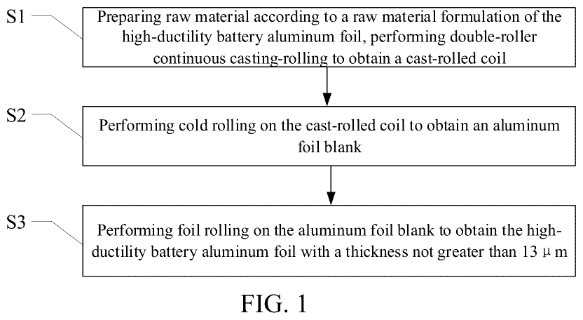

The embodiment of the present disclosure provides a method for preparing the high-ductility battery aluminum foil. As shown in FIG. 1, the method for preparing the high-ductility battery aluminum foil includes following steps:

S1: according to a raw material formulation of the high-ductility battery aluminum foil, performing double-roller continuous casting-rolling to obtain a cast-rolled coil;

A raw material formulation adopts the components and mass fractions of the high-ductility battery aluminum foil in above-mentioned Embodiment 1.

Specifically, the step S1 includes following sub-steps:

S11: preparing raw materials according to the raw material formulation; melting the raw materials into aluminum liquid;

Si is prepared by employing an AlSi20 intermediate alloy, Fe is prepared by employing aluminum-type iron agent 80FeAl, and Cu is prepared by employing an AlCu20 intermediate alloy. If the raw material formulation includes Ti and other elements, Ti is prepared by adding a grain refiner aluminum titanium boron wire, and the other alloys are not separately added.

Compared with a content of Si in the existing 1060 alloy power battery aluminum foil (less than 0.15%), a content of Si in the high-ductility battery aluminum foil is obviously increased, so that Si, Fe, and Al in the high-ductility battery aluminum foil form a AlFeSi phase, which reduce a content of large-size needle-shaped Al3Fe phase. The formation of the AlFeSi phase makes the easier to break during a subsequent rolling deformation process, significantly improving the strength and elongation of the high-ductility battery aluminum foil.

Compared with a content of Cu in the existing 1060 alloy power battery aluminum foil (0.05%), a content of Cu in the high-ductility battery aluminum foil is decreased. Cu is presented in a solid solution form in a matrix. Increase of the content of Cu significantly improves a strength of the existing 1060 alloy power battery aluminum foil, but also makes it difficult to roll down the existing 1060 alloy power battery aluminum foil and leads to a decrease in elongation thereof. The content of t Cu is low in the present disclosure, which effectively reduces an impact of Cu on the elongation of the high-ductility battery aluminum foil. Table 1 shows performance comparisons of finished aluminum foils with different contents of Cu.

TABLE 1
Comparison of the performance of finished aluminum
foils based on different contents of Cu

| Cu content (%) | Tensile strength (MPa) | Elongation(%) |
|---|---|---|
| 0.12 | 306 | 3 |
| 0.03 | 254 | 5.5 |

The steps S11 include following sub-steps in sequence:
preparing the raw materials according to the raw material formulation;
smelting the raw materials in a smelting furnace;
adding Si, Fe, and Cu for alloying; if other components are in the raw material formulation adding them together for alloying;
performing a first refining;
slagging for a first time;
performing component analysis;
performing a second refining to obtain molten aluminum;
transferring the molten aluminum into a refining furnace; and
refining for the third time, slagging for the second time and resting to obtain the aluminum liquid;

When performing the first refining and the second refining, a granular refining agent is added under argon atmosphere, and a refining time is 12-25 minutes.

The raw materials are refined in the smelting furnace for two times, and during the first refining and the second refining, are respectively performed for 12-25 minutes by adding the particle refining agent under the argon atmosphere, so that the added components can be uniformly smelted.

S12: injecting aluminum liquid into a casting nozzle of a cast-rolling mill through a launder, and cooling the aluminum liquid by rolling rollers of the cast-rolling mill to obtain the cast-rolled coil.

A temperature of a front box of the cast-rolling mill is 690±3° C., and a temperature of a coolant in the cast-rolling mill is less than 30° C.

The cast-rolling mill is a large cast-rolling mill, and a diameter of each of the rolling rollers is greater than 800 mm. By such arrangement, a cooling speed of the aluminum liquid is effectively improved and a purpose of refining initial grains and the iron-containing second phase.

A rolling speed of the cast-rolling mill is 700±200 mm/min, which is significantly slower than a rolling speed of 1000±30 mm/min of a conventional cast-rolling mill in the prior art for preparing the existing 1060 alloy power battery aluminum foil. By controlling the rolling speed, a liquid hole depth of the aluminum liquid during a solidification process is reduced, thereby reducing problems of central layer segregation and agglomeration.

S2: performing cold rolling on the cast-rolled coil to obtain an aluminum foil blank.

Specifically, the cold rolling is performed via a four-roller cold-rolling mill.

In an existing production process of a power battery foil, intermediate annealing is performed when the cast-rolled coil is rolled to an intermediate thickness to eliminate internal stress during the rolling process. In the present embodiment, intermediate annealing is not performed, Through large rolling deformation, internal dislocation of the material structure and a crushing degree of the iron-containing second phase is improved, and the high strength and high elongation performance of the high-ductility battery aluminum foil is ensured.

Specifically, the cold rolling is performed in eight passes; when the cast-rolled coil is cold rolled to an intermediate thickness and a final thickness, the cast-rolled coil is trimmed. Due to an increased degree of alloying of the cast-rolled coil, the cast-rolled coil is thinned and cracks generate on the cast-rolled coil during the cold rolling process. The cracks are wider than cracks generated in the existing power battery process. Therefore, the cast-rolled coil is trimmed for twice, so that there are no notches on an end face of the aluminum foil blank, which ensures stability of the rolling process during subsequent foil rolling.

S3: performing foil rolling on the aluminum foil blank to obtain the high-ductility battery aluminum foil with a thickness not greater than 13 μm;

The foil rolling is performed by a foil rolling mill.

Before performing the cold rolling, a thickness of the cast-rolled coil is h0. After the foil rolling is performed on the aluminum foil blank, a thickness of the high-ductility battery aluminum foil is h. An equivalent strain coefficient is ln(h0/h)≥3.9.

In the present embodiment, a diameter of sub-grains of the high-ductility battery aluminum foil is not greater than 2.5 μm, and a area ratio of the sub-grains of the high-ductility battery aluminum foil is not less than 55%.

A method of measuring the sub-grains and calculating the area ratio of the sub-grains of the prepared high-ductility battery aluminum foil is as follows:

Cutting the high-ductility battery aluminum foil into a sample of a suitable size, mechanically polishing the sample; performing ion etching by an ion etching instrument; measuring by a scanning electron microscope with an electron backscattered biffraction (EBSD) system, and analyzing measurement data by CHANNEL 5 software. Specifically, the sub-grains are grains composed of small-angle grain boundaries with orientation differences not greater than 5°. The sub-grains with the same orientation difference have the same color; different colors are applied from 0°-5° to form a sub-crystal distribution cloud. When the orientation difference is greater than 5°, the sub-grains are marked in yellow. By calculating the area of the colored part of the sub-crystal distribution cloud and the area of the yellow part, the area ratio of the sub-grains is calculated.

Specifically, the foil rolling is performed in five passes; a roughness of rollers of the foil rolling mill is 0.06±0.01 μm, and a rolling speed of the foil rolling mill is 500˜700 m/minute. By rolling the aluminum foil blank through the rollers that are fine, and by reducing the rolling speed during the foil rolling, a microscopic flatness of a surface of the high-ductility battery aluminum foil is effectively controlled, preventing the performance degradation of the high-ductility battery aluminum foil applied to a positive fluid due to local microscopic unevenness of the high-ductility battery aluminum foil. Table 2 shows the performance comparison of the high-ductility battery aluminum foils applied in batteries with different rolling parameters:

TABLE 2
performance comparison of the high-ductility battery aluminum
foils applied in batteries with different rolling parameters

| Roller roughness | Rolling speed | Tensile strength | |
|---|---|---|---|
| (μm) | (m/min) | (MPa) | Elongation(%) |
| 0.08 | 800 | 245 | 4 |
| 0.06 | 600 | 254 | 5.5 |

In the present embodiment, the method of preparing the high-ductility battery aluminum foil adopts the components and mass fractions of the high-ductility battery aluminum foil in the embodiment 1, so the prepared high-ductility battery aluminum foil reaches the level of the high-ductility battery aluminum foil in the above embodiment 1. The technical effects are described in detail herein. In addition, the method of preparing the high-ductility battery aluminum foil does not require intermediate annealing in the entire process, and the preparation process is short, energy consumption is low, and the carbon emissions during the preparation cycle are less than equivalent products.

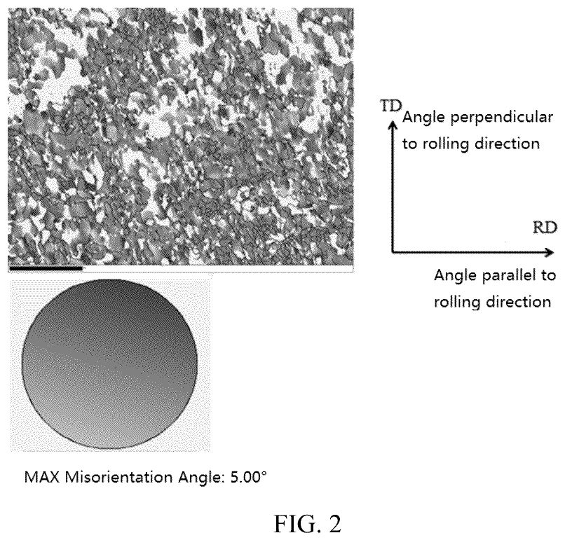

In one optional embodiment, the mass fraction of Si is 0.23%; the mass fraction of Fe is 0.32%; the mass fraction of Cu is 0.34%; the mass fraction ratio of Fe and Si is 1.39; and the method mentioned above is performed to obtain the high-ductility battery aluminum foil with a thickness of 13 μm, an equivalent strain coefficient ln(h0/h)=6.26, a tensile strength of 254 MPA, and an elongation of 5.5%. In addition, through the above-mentioned method of measuring the sub-grains and calculating the area ratio of the sub-grains of the prepared high-ductility battery aluminum foil, a corresponding sub-crystal distribution cloud diagram is obtained (as shown in FIG. 2). Through further calculation, an average diameter of the sub-grains of the high-ductility battery aluminum foil is 1.89 μm, and the area ratio of the sub-grains of the high-ductility battery aluminum foil is 61.9%.

The above are only optional embodiments of the present disclosure, and do not limit the patent scope of the present disclosure. Any equivalent structure or equivalent process transformation made by employing the description and drawings of the present disclosure, or directly or indirectly applied to other related technical fields are equally fall within the protection scope of the present disclosure.

What is claimed is:

1. A high-ductility battery aluminum foil, comprising:
a first component, and
a second component;
wherein the first component comprises 0.25˜0.40% of Si by mass fraction, 0.30˜0.50% of Fe by mass fraction, and 0.02˜0.10% of Cu by mass fraction; the second component is Al; a mass fraction ratio of Fe to Si is 1.0˜2.0;
a presence of iron-containing second phase with an equivalent circular diameter of 0.2˜3 μm, in a cross-section of the high ductility battery aluminum foil, is in a range of 1.1×10²˜4×10⁴ particles/mm²; a presence of metal intermetallic compounds, with an equivalent circular diameter of 0.2˜3 μm, formed by Si and Cu respectively with Al, in the cross-section of the high ductility battery aluminum foil, is not greater than 1.1×10² particles/mm²; a presence of elemental silicon particles with an equivalent circular diameter of 0.2˜3 μm, in the cross-section of the high ductility battery aluminum foil, is not greater than 1.1×10² particles/mm².

2. The high-ductility battery aluminum foil according to claim 1, wherein the first component further comprises a first group of elements, wherein the first group of elements in the high-ductility battery aluminum foil comprises following components by mass fraction: Mg≤0.20%, Mn≤0.20%, one or more rare earth elements≤0.15%.

3. The high-ductility battery aluminum foil according to claim 1, wherein the first component further comprises one or more elements in a second group of elements; the second group of elements in the high-ductility battery aluminum foil comprises following components by mass fraction: Cr≤0.20%, Zn≤0.20%, Ni≤0.20% and V≤0.20%.

4. The high-ductility battery aluminum foil according to claim 1, wherein the first component further comprises one or more elements in a third group of elements; the third group of elements in the high-ductility battery aluminum foil comprises following components by mass fraction: Ti≤0.20%, Zr≤0.20%, and Co≤0.20%.

5. The high-ductility battery aluminum foil according to claim 3, wherein the first component further comprises one or more elements in sub-elements of a third group of elements; the sub-elements of the third group of elements in the high-ductility battery aluminum foil comprise following components by mass fraction: Ti≤0.20%, Zr≤0.20% and Co≤0.20%.

6. The high-ductility battery aluminum foil according to claim 1, wherein the first component further comprises one or more elements in a fourth group of elements; the fourth group of elements in the high-ductility battery aluminum foil comprises following components by mass fraction: Be≤0.15%, Bi≤0.15%, Sr≤0.15% and In≤0.15%.

7. The high-ductility battery aluminum foil according to claim 3, wherein the first component further comprises one or more elements in first sub-elements of a fourth group of elements; the first sub-elements of the fourth group of elements in the high-ductility battery aluminum foil comprise following components by mass fraction: Be≤0.15%, Bi≤0.15%, Sr≤0.15% and In≤0.15%.

8. The high-ductility battery aluminum foil according to claim 4, wherein the first component further comprises one or more elements in second sub-elements of a fourth group of elements; the second sub-elements of the fourth group of elements in the high-ductility battery aluminum foil comprise following components by mass fraction: Be≤0.15%, Bi≤0.15%, Sr≤0.15% and In≤0.15%.

9. The high-ductility battery aluminum foil according to claim 5, wherein the first component further comprises one or more elements in third sub-elements of a fourth group of elements; the third sub-elements of the fourth group of elements in the high-ductility battery aluminum foil comprise following components by mass fraction: Be≤0.15%, Bi≤0.15%, Sr≤0.15% and In≤0.15%.

10. A method for preparing a high-ductility battery aluminum foil, comprising following steps:
S1: according to the components and mass fraction of the high-ductility battery aluminum foil according to claim 1, performing double-roller continuous casting-rolling to obtain a cast-rolled coil;
S2: performing cold rolling on the cast-rolled coil to obtain an aluminum foil blank; and
S3: performing foil rolling on the aluminum foil blank to obtain the high-ductility battery aluminum foil with a thickness not greater than 13 μm;
wherein before performing the cold rolling, a thickness of the cast-rolled coil is h0; after the foil rolling is performed on the aluminum foil blank, the thickness of the high-ductility battery aluminum foil is h; an equivalent strain coefficient is ln(h0/h)≥3.9.

11. The method for preparing the high-ductility battery aluminum foil according to claim 10, wherein a sub-grain diameter of the high-ductility battery aluminum foil is not greater than 2.5 μm, and a sub-grain area ratio of the high-ductility battery aluminum foil is not less than 55%.
